(19) United States
(12) Patent Application Publication
(10) Pub. No.: US 2025/0171348 A1
(43) Pub. Date: May 29, 2025

(54) ACID ETCHING PROCESS OF MAKING ANTI-GLARE TEXTURED GLASS CERAMICS FOR CONSUMER ELECTRONIC APPLICATION

(71) Applicant: CORNING INCORPORATED, CORNING, NY (US)

(72) Inventors: Chelsea Ann Bennett, Corning, NY (US); Yuhui Jin, Painted Post, NY (US); Meng Shang, Painted Post, NY (US)

(21) Appl. No.: 18/952,672

(22) Filed: Nov. 19, 2024

Related U.S. Application Data
(60) Provisional application No. 63/603,970, filed on Nov. 29, 2023.

(51) Int. Cl. C03C 10/00; C03C 15/00; C03C 23/00

(52) U.S. Cl. CPC C03C 10/0027; C03C 15/00; C03C 23/0075

(57) ABSTRACT

A method of making a glass-ceramic article having a textured region is provided. The method comprises: (1) acid rinsing a glass-ceramic substrate in a rinsing solution comprising HF, and optionally HCl, to form a rinsed region; (2) etching the rinsed region in an etching solution comprising HF and NH₄F, and optionally KCl, NaCl, MgCl₂, propylene glycol and mixtures thereof; to form an etched region; and (3) chemically polishing the etched region in a polishing solution comprising HF, and optionally HCl, HNO₃ and mixtures thereof, to form the textured region. Related glass-ceramic articles are also provided.

This application claims the benefit of priority of U.S. Provisional Application Ser. No. 63/603,970 filed Nov. 29, 2023, the contents of which is incorporated by reference in its entirety.

### FIELD

The present disclosure generally relates to textured, antiglare glass articles and methods of making the same, particularly textured glass articles with low haze and sparkle characteristics.

### BACKGROUND

Antiglare surfaces are often used in display devices such as LCD screens, tablets, smartphones, OLEDs and touch screens to avoid or reduce specular reflection of ambient light. In many display devices, these antiglare surfaces are formed by providing a level of roughness to one or more surfaces of the glass to spread and scatter incident light. Antiglare surfaces in the form of a roughened glass surface are often used on the front surfaces of these display devices to reduce the apparent visibility of external reflections from the display and improve readability of the display under differing lighting conditions.

Display “sparkle” or “dazzle” is a phenomenon that can occur when antiglare or light scattering surfaces are incorporated into a display system. Sparkle is the expression of a non-uniform pixel light intensity distribution. Further, sparkle is associated with a very fine grainy appearance that can appear to have a shift in the pattern of the grains with changing viewing angle of the display. This type of sparkle is observed when pixelated displays, such as LCDs, are viewed through an antiglare surface. As the resolution of display devices continues to increase, particularly for handheld electronic devices, the pixel pitch of the array of pixels employed in these devices continues to decrease, exacerbating unwanted sparkle effects.

Conventional approaches to making textured, antiglare glass surfaces have been successful at producing surfaces with good antiglare properties. However, these textured, antiglare surfaces have exhibited high degrees of sparkle. Common surface treatments and other processes aimed at reducing sparkle tend to successfully reduce sparkle, but at the expense of antiglare properties, such as DOI, haze and/or transmission. It is particularly difficult to achieve a combination of low sparkle, high DOI, low haze and high transmission, because improving one attribute often comes at the cost of worsening another.

Glass-ceramic is a relatively new material for use as a transparent cover glass for mobile consumer electronics. There are significant compositional and structural differences between glass and glass ceramic. As such, there is a need for textured glass ceramic surfaces and articles with a combination of low sparkle and high DOI characteristics, as well as low haze and high transmission. There is also a need for methods of making such surfaces and articles that are amenable to manufacturing at low cost and high throughput.

### SUMMARY

In a first aspect, a method of making a glass-ceramic article having a textured region is provided. The method comprises: (1) acid rinsing a glass-ceramic substrate in a rinsing solution comprising HF, and optionally HCl, to form a rinsed region; (2) etching the rinsed region in an etching solution comprising HF and NH₄F, and optionally KCl, NaCl, MgCl₂, propylene glycol and mixtures thereof; to form an etched region; and (3) chemically polishing the etched region in a polishing solution comprising HF, and optionally HCl, HNO₃ and mixtures thereof, to form the textured region.

In a second aspect, for the method of the first aspect: the glass-ceramic substrate comprises a first primary surface and a second primary surface separated by a thickness; the second primary surface is covered by a protective film during the acid rinsing, etching and chemical polishing, such that the second primary surface is excluded from the rinsed region, the etched region and the textured region; and the rinsed region, the etched region and the textured region comprise the first primary surface.

In a third aspect, for the method of any of the first and second aspects: the rinsing solution comprises greater than or equal to 1 wt % to less than or equal to 10 wt % HF, and greater than or equal to 5 wt % to less than or equal to 30 wt % HCl.

In a fourth aspect, for the method of any of the first through third aspects, the acid rinsing comprises exposing the substrate to the rinsing solution for greater than or equal to 0.5 minutes to less than or equal to 3 minutes.

In a fifth aspect, for the method of any of aspects 1 through 4, the etching solution comprises:
an etchant comprising:
   greater than or equal to 1 wt % to less than or equal to 20 wt % HF,
   a masking component comprising greater than or equal to 5 wt % to less than or equal to 50 wt % NH₄,
a masking modifier comprising:
   greater than or equal to 0 wt % to less than or equal to 20 wt % KCl,
   greater than or equal to 0 wt % to less than or equal to 20 wt % NaCl,
   greater than or equal to 0 wt % to less than or equal to 20 wt % MgCl₂; and
   greater than or equal to 0 wt % to less than or equal to 30 wt % propylene glycol;
      wherein at least one of the KCl, NaCl, MgCl₂ and propylene glycol is present in an amount greater than or equal to 0.1 wt %.

In a sixth aspect, for the method of any of aspects 1 through 5, the etching comprises exposing the substrate to the etching solution for greater than or equal to 2 minutes to less than or equal to 20 minutes.

In a seventh aspect, for the method of any of aspects 1 through 6, the polishing solution comprises: a polisher comprising greater than or equal to 1 wt % to less than or equal to 10 wt % HF, and a polishing modifier comprising greater than or equal to 0 wt % to less than or equal to 30 wt % HCl and greater than or equal to 0 wt % to less than or equal to 30 wt % HNO₃.

In an eighth aspect, for the method of any of aspects 1 through 7, wherein the polishing comprises exposing the substrate to the polishing solution for greater than or equal to 20 minutes to less than or equal to 120 minutes.

In a ninth aspect, for the method of any of aspects 1 through 8, the glass-ceramic substrate comprises: a petalite crystalline phase; and a lithium silicate crystalline phase, wherein the petalite crystalline phase and the lithium silicate crystalline phase have higher weight percentages than other crystalline phases present in the glass-ceramic article.

In a tenth aspect, for the method of aspect 9, the petalite crystalline phase comprises 20 to 70 wt % of the glass-ceramic article and the lithium silicate crystalline phase comprises 20 to 60 wt % of the glass ceramic substrate.

In an eleventh aspect, for the method of any of aspects 1 through 10, the glass-ceramic article has a composition comprising, in wt %:
SiO₂: 55-80%;
Al₂O₃: 2-20%;
Li₂O: 5-20%;
B₂O₃: 0-10%;
Na₂O: 0-5%;
ZnO: 0-10%;
P₂O₅: 0.5-6%; and
ZrO₂: 0.2-15%.

In a twelfth aspect, for the method of any of aspects 1 through 11, the glass-ceramic substrate is made of a material that has a transmittance of at least 90% for light in a wavelength range from 400 nm to 800 nm at a thickness of 1 mm.

In a thirteenth aspect, for the method of any of aspects 1 through 12, the glass-ceramic article with a textured region comprises a transmittance haze of greater than or equal to 10% to less than or equal to 40%.

In a fourteenth aspect, for the method of any of aspects 1 through 13, the glass-ceramic article with a textured region comprises a sparkle of greater than or equal to 1% to less than or equal to 5% as measured by pixel power distribution (PPD) at 140 ppi.

In a fifteenth aspect, for the method of any of aspects 1 through 14, the glass-ceramic article with a textured region comprises a coupled distinctness of image (DOI) of greater than or equal to 50% to less than or equal to 99.9%.

In a sixteenth aspect, for the method of any of aspects 1 through 15, the glass-ceramic article with a textured region comprises:
a transmittance haze of greater than or equal to 10% to less than or equal to 40%;
a sparkle of greater than or equal to 1% to less than or equal to 5% as measured by pixel power distribution (PPD) at 140 ppi; and
a coupled distinctness of image (DOI) of greater than or equal to 50% to less than or equal to 99.9%.

In a seventeenth aspect, for the method of any of aspects 1 through 16, the textured region has a mean width of profile elements (RSM) of greater than or equal to 10 microns to less than or equal to 30 microns.

In an eighteenth aspect, for the method of any of aspects 1 through 17, the textured region has a root mean square height (Sq) of greater than or equal to 0.1 microns to less than or equal to 0.5 microns.

In a nineteenth aspect, the method of any of aspects 1 through 18 further comprising ion exchanging the substrate after forming the textured region.

In a twentieth aspect, a glass-ceramic article comprises:

a first primary surface and a second primary surface separated by a thickness, wherein the first primary surface comprises a textured region,
a transmittance haze of greater than or equal to 10% to less than or equal to 40%;
a sparkle of greater than or equal to 1% to less than or equal to 5% as measured by pixel power distribution (PPD) at 140 ppi; and
a coupled distinctness of image (DOI) of greater than or equal to 50% to less than or equal to 99.9%; and
wherein the glass-ceramic article is made of a material that has a transmittance of at least 90% for light in a wavelength range from 400 nm to 800 nm at a thickness of 1 mm.

In a twenty-first aspect, for the glass-ceramic article of aspect 20, the textured region has a mean width of profile elements (RSM) of greater than or equal to 10 microns to less than or equal to 30 microns.

In a twenty-second aspect, for the glass-ceramic article of any of aspects 20 through 21, the textured region has a root mean square height (Sq) of greater than or equal to 0.1 microns to less than or equal to 0.5 microns.

In a twenty-third aspect, for the glass-ceramic article of any of aspects 20 through 22, the glass-ceramic substrate comprises:
a petalite crystalline phase; and
a lithium silicate crystalline phase,
wherein the petalite crystalline phase and the lithium silicate crystalline phase have higher weight percentages than other crystalline phases present in the glass-ceramic article.

In a twenty-fourth aspect, for the glass-ceramic article of any of aspects 20 through 23, wherein the petalite crystalline phase comprises 20 to 70 wt % of the glass-ceramic article and the lithium silicate crystalline phase comprises 20 to 60 wt % of the glass ceramic substrate.

In a twenty-fifth aspect, for glass-ceramic article of any of aspects 20 through 24, the glass ceramic substrate is made of a material that has a transmittance of at least 90% for light in a wavelength range from 400 nm to 800 nm at a thickness of 1 mm.

In a twenty-sixth aspect, for the glass-ceramic article of any of aspects 20 through 25, the glass-ceramic article has a composition comprising, in wt %:
SiO₂: 55-80%;
Al₂O₃: 2-20%;
Li₂O: 5-20%;
B₂O₃: 0-10%;
Na₂O: 0-5%;
ZnO: 0-10%;
P₂O₅: 0.5-6%; and
ZrO₂: 0.2-15%.

In a twenty-seventh aspect, for the glass-ceramic article of any of aspects 20 through 26, the article further comprises a compressive stress region that extends from the first primary surface to a selected depth.

In a twenty-eighth aspect, for the glass-ceramic article of any of aspects 20 through 27, the article further comprises a consumer electronic device.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 is a plan view of an exemplary electronic device incorporating any of the articles of the disclosure.

FIG. 2 is a perspective view of the exemplary electronic device of FIG. 1.

FIG. 3 is a flow chart of a method of making a textured, anti-glare glass article, according to an aspect of the disclosure.

FIG. 4 is a schematic cross-sectional view of a substrate illustrating the results of the steps of FIG. 3.

FIG. 5 shows surface views of actual glass ceramic samples illustrating the results of some of the steps of FIG. 3.

FIG. 6 shows optical microscope images of different glass-ceramic surfaces after an etching step, according to different conditions as shown in table 2.

FIG. 7 shows optical microscope images of different glass-ceramic surfaces after a polishing step, according to different conditions as shown in table 2.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Aspects of the disclosure generally pertain to textured, antiglare glass-ceramic articles and, particularly, textured, antiglare glass articles with low sparkle, high distinctness of image (DOI), low haze and high transmission.

The glass-ceramic articles described herein may be incorporated into a consumer electronic device, preferably as a transparent cover a display. Exemplary consumer electronic devices include smart phones, tablets computers, navigation systems, and the like. In preferred embodiments, the glass-ceramic articles described herein are used as transparent covers over a touch screen, in which case the damage resistance of glass-ceramics combined with the superior optical properties described herein for use with a display provide a particularly favorable combination. Any device having such a touch screen may be considered a consumer electronic device. Other applications for the glass ceramic articles described herein include architectural articles, transportation articles (e.g., automotive, trains, aircraft, sea craft, etc.), appliance articles, or any article that could benefit from the combination of transparency, haze, DOI and sparkle described herein for a high durability glass-ceramic article.

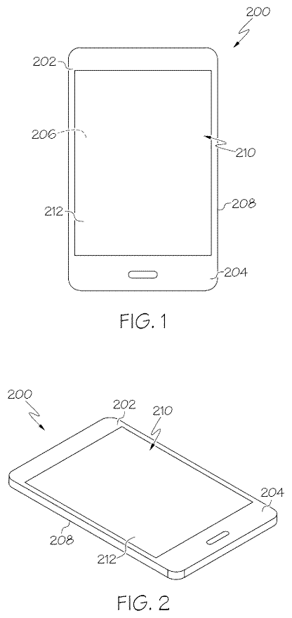

An exemplary consumer electronic device incorporating any of the glass articles disclosed herein is shown in FIG. 1 and FIG. 2. Specifically, FIGS. 1 and 2 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass articles disclosed herein.

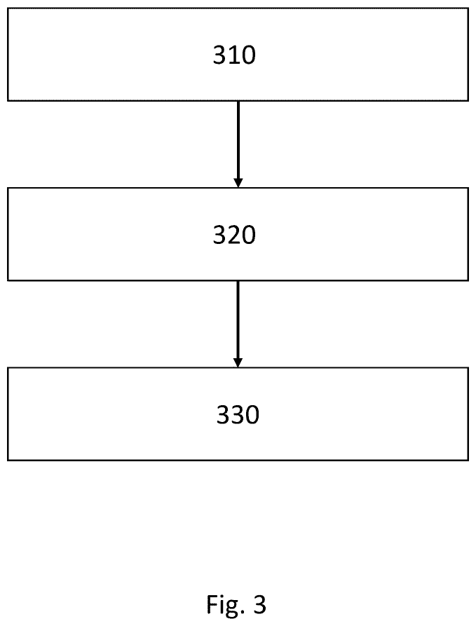

FIG. 3 shows a flow chart of a method of making a textured, anti-glare glass article, according to an aspect of the disclosure. First step 310 comprises acid rinsing a glass-ceramic substrate in a rinsing solution comprising HF, and optionally HCl, to form a rinsed region. Second step 320 comprises etching the rinsed region in an etching solution comprising HF and NH₄F, and optionally KCl, NaCl, MgCl₂, propylene glycol and mixtures thereof, to form an etched region. Third step 330 comprises chemically polishing the etched region in a polishing solution comprising HF, and optionally HCl, HNO₃ and mixtures thereof, to form the textured region.

### Rinsing

The purpose of rinsing, first step 310, is to clean the surface for further processing. Without rinsing there may be small particles of dirt or other impurity on the surface that have an undesirable effect on the etching step. Specifically, such impurities may interfere with or change the desired “masking” effect that occurs during the etching step. For example, an impurity may serve as a nucleation point for such masking, such that the masking effect is significantly affected by the impurities, which may be inconsistent from sample to sample and batch to batch. Rinsing allows the etching step to start with a surface that is consistent from sample to sample and batch to batch, such that the masking effect is consistently controlled by the composition of the etching solution and the basic material and properties of the glass-ceramic substrate.

The rinsing solution comprises HF, and optionally HCl. HF provides the basic light etch desired from the rinsing step to remove impurities and ensure a surface for subsequent processing that is uniform from sample to sample and batch to batch. The rinsing step is designed to clean without introducing surface features. HF preferentially attacks silica in a glass-ceramic, and HF alone will provide the desired effect. HCl preferentially etches alkaline metals, such as lithium and sodium. While HCl is not necessary for the rinsing step, it can significantly speed the process by providing an attack on the alkaline metals as well as the silica.

HF is present in the rinsing solution in an amount of 1 wt % to 10 wt %. Preferably, the range of HF is 4 wt % to 8 wt %. The amount of HF in the rinsing solution may be 1 wt %, 2 wt %, 3 wt %, 4 wt %, 5 wt %, 6 wt %, 7 wt %, 8 wt %, 9 wt %, 10 wt %, or any range having any two of these values as endpoints.

HCl is present in the rinsing solution in an amount of 0 wt % to 30 wt %. When HCl is present in the rinsing solution, it is preferably present in an amount of 5 wt % to 30 wt %, more preferably 5 wt % to 15 wt %. The amount of HF in the rinsing solution may be 0 wt %, 5 wt %, 10 wt %, 15 wt %, 20 wt %, 25 wt %, 30 wt %, or any range having any two of these values as endpoints.

During rinsing, the part of the glass-ceramic substrate that will become the textured region is exposed to the rinsing solution for 0.5 to 3 minutes. The exposure time may be 0.5 minutes, 1 minute, 1.5 minutes, 2 minutes, 2.5 minutes, 3 minutes, or any range having any two of these values as endpoints. Longer rinse times may technically be used, but are not preferred because the longer times take longer and cost more, and do not provide additional beneficial effect once the impurities are removed.

### Etching

The purpose of etching, second step 320, is to introduce surface features onto the rinsed region in a specific way, to form an etched region.

The etching solution comprises HF and NH₄F. HF, as in the other steps, removes material by preferentially attacking silica in the substrate. Including NH₄F in the etching solution, in the range described, causes ammonium silica fluoride deposits to precipitate and grow on parts but not all of the surface of the substrate, resulting in a mask during etching. As such, NH₄F may be referred to as a “masking component.” The presence of this mask causes the generate of etched features on the substrate, with hills under the masked portion and valleys under the unmasked portion.

The optional addition of salts such as KCl, NaCl, and/or MgCl₂ to the etching solution in the ranges described results in metal silicon fluoride precipitation in addition to or instead of ammonium silica fluoride, where the “metal” is, e.g., K, Na or Mg. This additional precipitation can be used to control how the precipitate nucleates and grows, and thus the feature size and spacing created by the etching step. As such, the KCl, NaCl, and/or MgCl₂ may be referred to as a “masking modifier.”

The optional addition of propylene glycol to the etching solution in the ranges described helps with uniform mask precipitation, and inhibits accumulation of too much mask material in a specific region. As such, the propylene glycol may be referred to as a “masking modifier,” though it modifies the mask in a different way from KCl, NaCl, and/or MgCl₂.

Preferably, at least one masking modifier is present in an amount 0.1 wt % or greater.

The etching described herein is particularly favorable because it allows the creation of etched features under a “mask” without a separate step to create the mask. Rather, the mask deposits on the substrate from the etching solution itself.

HF is present in the etching solution in an amount of 1 wt % to 20 wt %. Preferably, the range of HF is 2 wt % to 12 wt %, more preferably 4 wt % to 8 wt %. The amount of HF in the rinsing solution may be 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, or any range having any two of these values as endpoints.

NH₄F is present in the etching solution in an amount of 5 wt % to 50 wt %. Preferably, the range of NH₄F is 10 wt % to 40 wt %, more preferably 25 wt % to 35 wt %. The amount of NH₄F in the etching solution may be 10 wt %, 15 wt %, 20 wt %, 25 wt %, 30 wt %, 35 wt %, 40 wt %, 45 wt %, 50 wt %, or any range having any two of these values as endpoints.

Each of KCl, NaCl, and MgCl₂ is independently present in the etching solution in an amount of 0 wt % to 20 wt %. Preferably, at least one of KCl, NaCl, and MgCl₂ is present in the etching solution in an amount of 1 wt % to 12 wt %, more preferably 1 wt % to 3 wt %. The amount of each of KCl, NaCl, and MgCl₂ present in the etching solution, independently, may be 0 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, or any range having any two of these values as endpoints.

Propylene glycol is present in the etching solution in an amount of 0 wt % to 30 wt %. Preferably, propylene glycol is present in the etching solution in an amount of 2 wt % to 28 wt %, more preferably 6 wt % to 14 wt %. The amount of propylene glycol present in the etching solution may be 0 wt %, 2 wt %, 4 wt %, 6 wt %, 8 wt %, 10 wt %, 12 wt %, 14 wt %, 16 wt %, 18 wt %, 20 wt %, 22 wt %, 24 wt %, 26 wt %, 28 wt %, 30 wt %, or any range having any two of these values as endpoints.

During etching, the part of the glass-ceramic substrate that will become the textured region is exposed to the etching solution for 2 to 20 minutes. The exposure time may be 2 minutes, 4 minute, 6 minutes, 8 minutes, 10 minutes, 12 minutes, 14 minutes, 16 minutes, 18 minutes, 20 minutes, or any range having any two of these values as endpoints. Different etch times may be used, but are less preferred.

### Polishing

The purpose of polishing, third step 330, is to partially flatten the features of the etched region to form a textured region having the texture as taught in embodiments of this disclosure.

The polishing solution comprises HF, and optionally HCl and/or HNO₃. HF provides the basic removal of material desired in the polishing step. HF preferentially attacks silica in a glass-ceramic, and HF alone will provide the desired effect. HCl and/or HNO₃ preferentially attack alkaline metals, such as lithium and sodium. While HCl and/or HNO₃ are not necessary for the polishing step, they can significantly speed the process by providing an attack on the alkaline metals as well as the silica.

HF is present in the polishing solution in an amount of 1 wt % to 10 wt %. Preferably, the range of HF is 4 wt % to 8 wt %. The amount of HF in the polishing solution may be 1 wt %, 2 wt %, 3 wt %, 4 wt %, 5 wt %, 6 wt %, 7 wt %, 8 wt %, 9 wt %, 10 wt %, or any range having any two of these values as endpoints.

HCl is present in the polishing solution in an amount of 0 wt % to 30 wt %. When HCl is present in the polishing solution, it is preferably present in an amount of 5 wt % to 25 wt %, more preferably 10 wt % to 20 wt %. The amount of HCl in the polishing solution may be 0 wt %, 5 wt %, 10 wt %, 15 wt %, 20 wt %, 25 wt %, 30 wt %, or any range having any two of these values as endpoints.

HNO₃ is present in the polishing solution in an amount of 0 wt % to 30 wt %. When HNO₃ is present in the polishing solution, it is preferably present in an amount of 5 wt % to 25 wt %, more preferably 10 wt % to 20 wt %. The amount of HNO₃ in the polishing solution may be 0 wt %, 5 wt %, 10 wt %, 15 wt %, 20 wt %, 25 wt %, 30 wt %, or any range having any two of these values as endpoints.

During polishing, the part of the glass-ceramic substrate that will become the textured region is exposed to the polishing solution for 20 to 120 minutes. The exposure time may be 20 minutes, 30 minutes, 40 minutes, 50 minutes, 60 minutes, 70 minutes, 80 minutes, 90 minutes, 100 minutes, 110 minutes, 120 minutes, or any range having any two of these values as endpoints. Shorter or longer polish times may technically be used, particularly if some other condition such as temperature is changed to achieve a similar result as the preferred times at room temperature, but are not preferred.

### Temperature

Each of the rinsing, etching and polishing steps are preferably performed at or near room temperature, which as used herein means 15° C. to 30° C., and preferably 20° C. to 25° C. Lower temperatures may technically be used, but such temperatures may require extra equipment, and will slow the process. Higher temperatures may be used, and such temperatures may desirably speed up the process steps. However, higher temperatures typically require extra equipment, and there are environmental and safety issues associated with using the chemicals described herein at higher temperatures. So, the advantage of higher temperatures is not worth the cost.

### Schematics

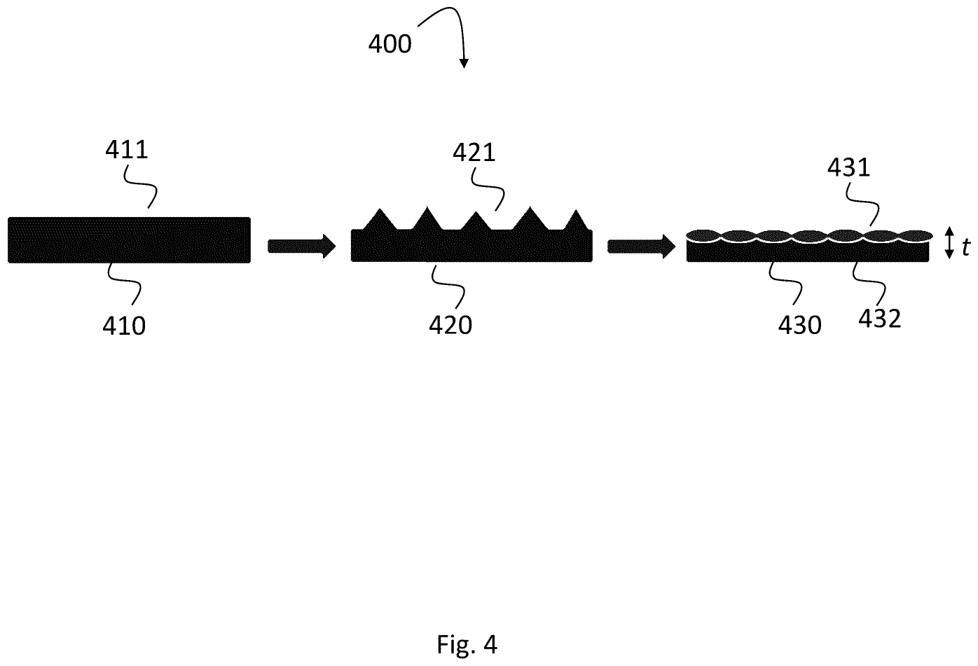

FIG. 4 shows schematic cross-sectional views 400 of a substrate after successive process steps, illustrating the results of the steps of FIG. 3. The final glass-ceramic article 430, which is the result of third step 330, has a first primary surface 431 and a second primary surface 432 separated by a thickness t. As illustrated, first primary surface 431 is a textured region, and second primary surface 432 is not textured, as a result of masking second primary surface 432 during the rinsing, etching and polishing steps. As one of skill in the art can appreciate, the substrate can be masked in any of a number of different patterns to locate the textured region wherever desired, whether partially or entirely covering one or both primary surfaces. Locating the textured region on one surface only, at least in the area intended to cover a display screen and optionally the bezels, is preferred.

Substrate 410 illustrates the results of first step 310, at which time the substrate has rinsed region 411. Substrate 420 illustrates the results of second step 320, at which time the substrate has etched region 421.

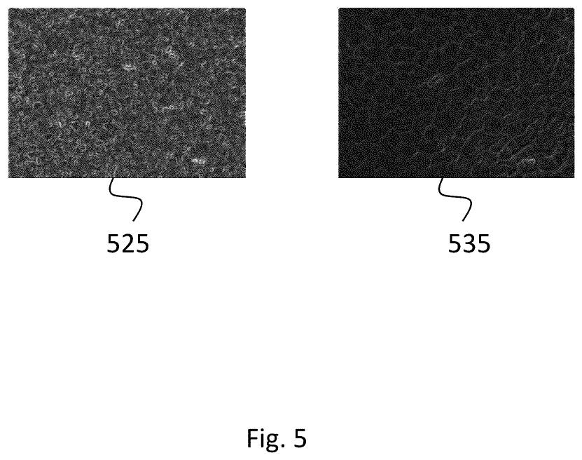

FIG. 5 shows optical microscope images. Image 525 is an example of an etched region. Image 535 is an example of a textured region. An image is not provided for the rinsed region, because it is featureless at the scale imaged.

### Attributes

According to implementations of the textured, anti-glare glass article described herein, the article is characterized by a low level of sparkle. In general, the roughness associated with its exposed features of these articles can begin to act like a plurality of lenses that generates an image artifact called “sparkle”. Display “sparkle” or “dazzle” is a generally undesirable side effect that can occur when introducing antiglare or light scattering surfaces into a pixelated display system such as, for example, an LCD, an OLED, touch screens, or the like, and differs in type and origin from the type of “sparkle” or “speckle” that has been observed and characterized in projection or laser systems. Sparkle is associated with a very fine grainy appearance of the display, and may appear to have a shift in the pattern of the grains with changing viewing angle of the display. Display sparkle may be manifested as bright and dark or colored spots at approximately the pixel-level size scale.

As used herein, the terms “pixel power deviation” and “PPD” refer to the quantitative measurement for display sparkle. Further, as used herein, the term “sparkle” is used interchangeably with “pixel power deviation” and “PPD.” PPD is calculated by image analysis of display pixels according to the following procedure. A grid box is drawn around each LCD pixel. The total power within each grid box is then calculated from CCD camera data and assigned as the total power for each pixel. The total power for each LCD pixel thus becomes an array of numbers, for which the mean and standard deviation may be calculated. The PPI) value is defined as the standard deviation of total power per pixel divided by the mean power per pixel (times 100). The total power collected from each LCD pixel by the eye simulator camera is measured and the standard deviation of total pixel power (PPD) is calculated across the measurement area, which typically comprises about 30×30 LCD pixels.

The details of a measurement system and image processing calculation that are used to obtain PPD values are described in U.S. Pat. No. 9,411,180 entitled “Apparatus and Method for Determining Sparkle,” the salient portions of which that are related to PPD measurements are incorporated by reference herein in their entirety. Further, unless otherwise noted, the SMS-1000 system (Display-Messtechnik & Systeme GmbH & Co. KG) is employed to generate and evaluate the PPD measurements of this disclosure. The PPD measurement system includes: a pixelated source comprising a plurality of pixels (e.g., a Lenovo Z50 140 ppi laptop), wherein each of the plurality of pixels has referenced indices i and j; and an imaging system optically disposed along an optical path originating from the pixelated source. The imaging system comprises: an imaging device disposed along the optical path and having a pixelated sensitive area comprising a second plurality of pixels, wherein each of the second plurality of pixels are referenced with indices n and n; and a diaphragm disposed on the optical path between the pixelated source and the imaging device, wherein the diaphragm has an adjustable collection angle for an image originating in the pixelated source. The image processing calculation includes: acquiring a pixelated image of the transparent sample, the pixelated image comprising a plurality of pixels; determining boundaries between adjacent pixels in the pixelated image; integrating within the boundaries to obtain an integrated energy for each source pixel in the pixelated image; and calculating a standard deviation of the integrated energy for each source pixel, wherein the standard deviation is the power per pixel dispersion. As used herein, all “PPD” and “sparkle” values, attributes and limits are calculated and evaluated with a test setup employing a display device having a pixel density of 140 pixels per inch (PPI) (also referred herein as “PPD₁₄₀”).

As generally described herein, the textured region can be configured to minimize sparkle. In some embodiments, the textured region is configured to minimize sparkle, while maintaining other attributes such as DOI, haze and transmission, as outlined in greater detail later in this disclosure, suitable for display device applications. According to some embodiments, the textured region, for example first primary surface 431, is configured such that the article is characterized by a sparkle of 5% or less, as measured by a PPD distribution. In other aspects, the textured, antiglare glass articles 430 of the disclosure can be configured with a sparkle of 1% or more and 5% or less. The sparkle may be 1%, 2%, 3%, 4% or 5%, and all sparkle ranges having two of these values as endpoints.

Referring again to the textured first primary surface 431 and article 430, the article can also be configured for optimal image quality and resolution, as manifested by high distinctness of image (DOI) values. As used herein, “DOI” is equal to 100*(Rₛ−R_{0.3°})/Rₛ, where Rₛ is the specular reflectance flux measured from incident light (at 30° from normal) directed onto a textured region of a textured, antiglare glass article of the disclosure and R_{0.3°} is the reflectance flux measured from the same incident light at 0.30° from the specular reflectance flux, Rₛ. Unless otherwise noted, the DOI values and measurements reported in this disclosure are obtained according to the ASTM D5767-18 Standard Test Method for Instrumental Measurement of Distinctness-of-Image (DOI) Gloss of Coated Surfaces using a Rhopoint IQ Gloss Haze & DOI Meter (Rhopoint Instruments Ltd.). The DOI values reported herein are “coupled” DOI values, which means that the non-textured primary surface of the substrate is coupled to the metrology equipment using an index matching fluid. Notably, the textured, antiglare glass-ceramic articles 430 of the disclosure can exhibit desirable coupled DOI (e.g., 50%-99.9%) without significant reductions in antiglare performance, as manifested in high DOI values. In implementations, the textured, antiglare glass-ceramic article 430 of the disclosure can be configured with a coupled DOI of 50% or more, or 50% to 99.9%. In other embodiments, the textured, antiglare glass articles 100 of the disclosure can be configured with a DOI of 50%, 55%, 60%, 55%, 70%, 75%, 80%, 85%, 90%, 95%, 99.9%, and all DOI ranges having any two of these values as endpoints.

As used herein, the terms “transmission haze” and “haze” refer to the percentage of transmitted light scattered outside an angular cone of about ±2.5° in accordance with ASTM procedure D1003, entitled “Standard Test Method for Haze and Luminous Transmittance of Transparent Plastics,” the contents of which is incorporated by reference herein in its entirety. For an optically smooth surface, transmission haze is generally close to zero. According to implementations of the textured, antiglare glass-ceramic articles 430 depicted in FIG. 3, the articles can be characterized by a haze of 40% or less. In other implementations, for particular applications, textured, antiglare glass-ceramic articles 430 consistent with the principles of this disclosure can be fabricated with haze levels that are preferably 10% to 40%, or 20 to 40%. The haze level may be 0%, 5%, 10%, 15%, 20%, 25%, 30%, 35%, 40%, or any haze range having two of these values as endpoints.

The methods disclosed herein are intended for use specifically with transparent glass-ceramic materials used as cover glass for a display. While a variety of texturing processes for glass substrates used in the same display context are known, it is not clear that such processes would work with a glass-ceramic material, due to the fundamental difference in material structure, specifically the presence of one or more crystalline phases in the glass-ceramic material.

The examples disclosed herein were performed on a class of glass ceramics that is being increasingly used as cover glass in mobiles consumer electron devices, specifically a glass-ceramic having a petalite crystalline phase and a lithium silicate crystalline phase, wherein the petalite crystalline phase and the lithium silicate crystalline phase have higher weight percentages than other crystalline phases present in the glass-ceramic article. In some embodiments, the petalite crystalline phase comprises 20 to 70 wt % of the glass-ceramic article and the lithium silicate crystalline phase comprises 20 to 60 wt % of the glass ceramic article. In some embodiments, the petalite crystalline phase comprises 45 to 70 wt % of the glass-ceramic article and the lithium silicate crystalline phase comprises 20 to 50 wt % of the glass ceramic article. In some embodiments, the petalite crystalline phase comprises 40 to 60 wt % of the glass-ceramic article and the lithium silicate crystalline phase comprises 20 to 50 wt % of the glass ceramic article.

In some embodiments, the glass-ceramic has a composition comprising, in wt %:
SiO₂: 55-80%;
Al₂O₃: 2-20%;
Li₂O: 5-20%;
B₂O₃: 0-10%;
Na₂O: 0-5%;
ZnO: 0-10%;
P₂O₅: 0.5-6%; and
ZrO₂: 0.2-15%.
   This composition space is well-suited to provide a glass-ceramic having the crystalline phases described above, which are particularly well suited for cover glass applications due to their favorable attributes. More details on suitable composition space and crystalline phases can be found in U.S. Pat. No. 10,239,780, which is incorporated by reference in its entirety.

### IOX

According to other embodiments, the glass substrate 10 of the textured, antiglare glass article 100 depicted in FIG. 1 can possess an ion-exchangeable glass composition that is strengthened by either chemical or thermal means that are known in the art. In one embodiment, the glass substrate is chemically strengthened by ion exchange. In this process, metal ions at or near a primary surface 12 and/or primary surface 14 of the glass substrate 10 are exchanged for larger metal ions having the same valence as the metal ions in the glass substrate. The exchange is generally carried out by contacting the glass substrate 10 with an ion exchange medium such as, for example, a molten salt bath that contains the larger metal ion. The metal ions are typically monovalent metal ions such as, for example, alkali metal ions. In one non-limiting example, chemical strengthening of a glass substrate 10 that contains sodium ions by ion exchange is accomplished by immersing the glass substrate 10 in an ion exchange bath comprising a molten potassium salt such as potassium nitrate (KNO₃) or the like. In one particular embodiment, the ions in the surface layer of the glass substrate 10 and the larger ions are monovalent alkali metal cations, such as Li⁺ (when present in the glass), Na⁺, K⁺, Rb⁺, and Cs⁺. Alternatively, monovalent cations in the surface layer of the glass substrate 10 may be replaced with monovalent cations other than alkali metal cations, such as Ag⁺ or the like.

In these embodiments of the textured, antiglare glass article 100 depicted in FIG. 1, the replacement of small metal ions by larger metal ions in the ion exchange process creates a compressive stress region 50 in the glass substrate 10 that extends from the primary surface 12 to a depth 52 (referred to as the “depth of layer”) that is under compressive stress. It should also be understood that a compressive stress region can be formed in the glass substrate that extends from the primary surface 14 to a depth (not shown in FIG. 1) that is comparable in nature to the compressive stress region 50. More particularly, this compressive stress at the primary surface of the glass substrate is balanced by a tensile stress (also referred to as “central tension”) within the interior of the glass substrate. In some embodiments, the primary surface 12 of the glass substrate 10 described herein, when strengthened by ion exchange, has a compressive stress of at least 350 MPa, and the region under compressive stress extends to a depth 52, i.e., depth of layer, of at least 15 pin below the primary surface 12.

Ion exchange processes are typically carried out by immersing the glass substrate 10 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments, when employed with a glass substrate 10 having an alkali aluminosilicate glass composition, result in a compressive stress region 50 having a depth 52 (depth of layer) ranging from about 10 pam up to at least 50 Lm with a compressive stress ranging from about 200 MPa up to about 800 MPa, and a central tension of less than about 100 MPa.

As the etching and leaching processes that can be employed to create the textured region 30a of the textured, antiglare glass article 100, according to some embodiments, can remove alkali metal ions from the glass substrate 10 that would otherwise be replaced by a larger alkali metal ion during an ion exchange process, a preference exists for developing a compressive stress region 50 in the textured glass article 100 after the formation and development of the textured region 30a. In other embodiments, a compressive stress region 50 can be developed in the glass substrate 10 prior to development of the textured region 30a to a depth 52 sufficient to account for some loss in the depth of layer in the region 50 associated with the various treatments associated with forming the textured region 30a, as outlined below.

### EXAMPLES

The following examples describe various features and advantages provided by the disclosure, and are in no way intended to limit the invention and appended claims.

### Example 1—Substrates

Substrates of glass-ceramic were obtained. All of the substrates used in the examples herein were 50 mm×50 mm, and 0.6 mm thick, though embodiments of the disclosure can be used with substrates having a wide variety of dimensions. The substrates had a composition according to Table 1, in wt %:

TABLE 1

SiO₂: 73.8%;
Al₂O₃: 7.5%;
Li₂O: 11.1%;
B₂O₃: 0%;
Na₂O: 1.6%;
K₂O: 0.21%;
ZnO: 0%;
P₂O₅: 2.1%;
ZrO₂: 3.6%;
SnO₂: 0.23%
MgO: 0.01%;
CaO: 0.02%; and
Fe₂O₃: 0.04%.

More details on the material of the glass-ceramic substrates can be found in U.S. Pat. No. 10,239,780, which is incorporated by reference in its entirety. The range of materials described in U.S. Pat. No. 10,239,780 are sufficiently similar in composition, and in the nature of the crystalline and glassy components of the glass-ceramics, to the specific composition used in the examples herein that similar results are expected.

The substrates used for the examples herein were laminated on one side with an acid resistant polymer film, such that the rinsing, etching and polishing steps were applied to a region that consisted of only one major surface of the substrate, but not the other.

### Example 2—Rinsing

The substrates of Example 1 were subjected to a rinsing step. The rinsing solution had a composition as follows:

TABLE 2

| | HF (wt %) | HCl (wt %) |
|---|---|---|
| Rinsing Solution | 5 | 8 |

Each substrate was placed in the rinsing solution for 2 minutes at 23° C. temperature to form substrates having rinsed regions.

### Example 3—Etching

After completion of the rinsing process (Example 2, above), 11 different rinsed substrates were subjected to etching treatment in etching solutions having different compositions. The etching solution compositions used to produce Samples 1 through 11 were as follows:

TABLE 3

| texture Etchant# | NH4F (wt %) | HF (wt %) | PG (%) | KCl |
|---|---|---|---|---|
| 1 | 15 | 10 | 0 | 2 |
| 2 | 15 | 10 | 0 | 10 |
| 3 | 15 | 10 | 25 | 2 |
| 4 | 15 | 10 | 25 | 10 |
| 5 | 15 | 6 | 0 | 2 |
| 6 | 15 | 6 | 0 | 10 |
| 7 | 15 | 6 | 25 | 2 |
| 8 | 15 | 6 | 25 | 10 |
| 9 | 5 | 6 | 0 | 2 |
| 10 | 30 | 6 | 0 | 2 |
| 11 | 30 | 6 | 10 | 2 |

Each substrate was placed in the etching solution for 8 minutes at 23° C. temperature to form substrates having etched regions, labeled Samples 1 through 11.

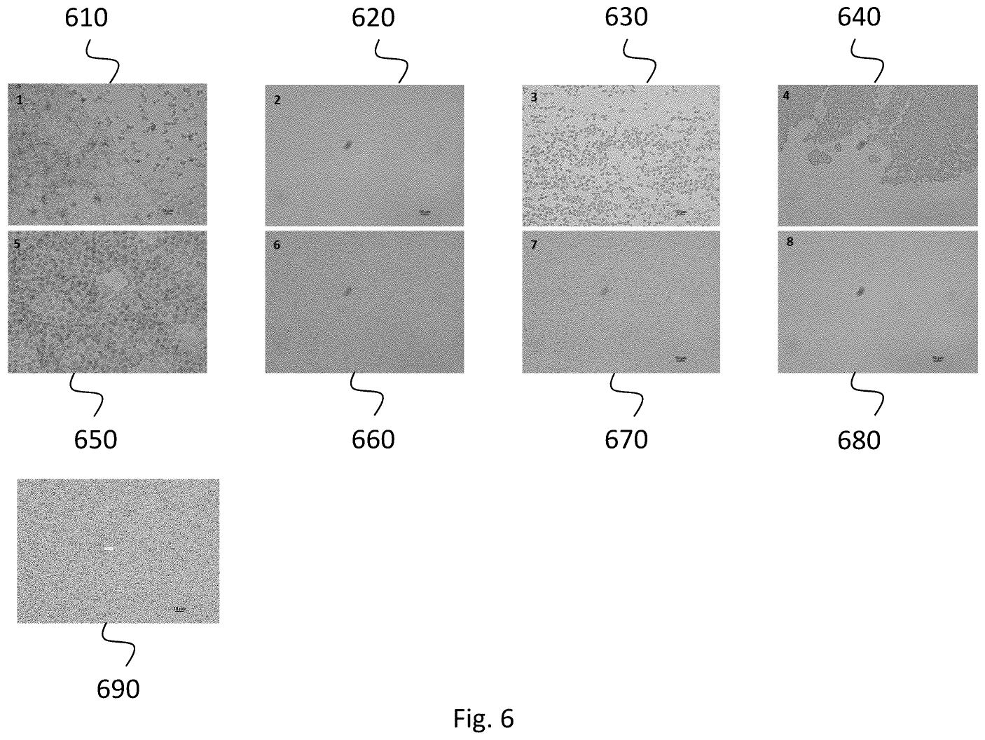

FIG. 6 shows optical microscope images of the etched regions for Samples 1 through 8. Specifically, FIG. 6 shows optical micrograph image 610 for Sample 1, image 620 for Sample 2, image 630 for Sample 3, image 640 for Sample 4, image 650 for Sample 5, image 660 for Sample 6, image 670 for Sample 7, image 680 for Sample 8, and image 690 for Sample 11. Sample 11, with 10 wt % PG, had the best uniform coverage of the etched region with etched features.

### Example 4—Polishing

Samples 10 and 11, after etching as described in Example 3, were further subjected to a polishing step. The polishing solution composition used on both samples was as follows:

TABLE 4

| | HF (wt %) |
|---|---|
| Polishing solution | 5 |

Each of Sample 10 and 11 were placed in the polishing solution for 45 minutes at 2323° C. temperature to form substrates having polished regions.

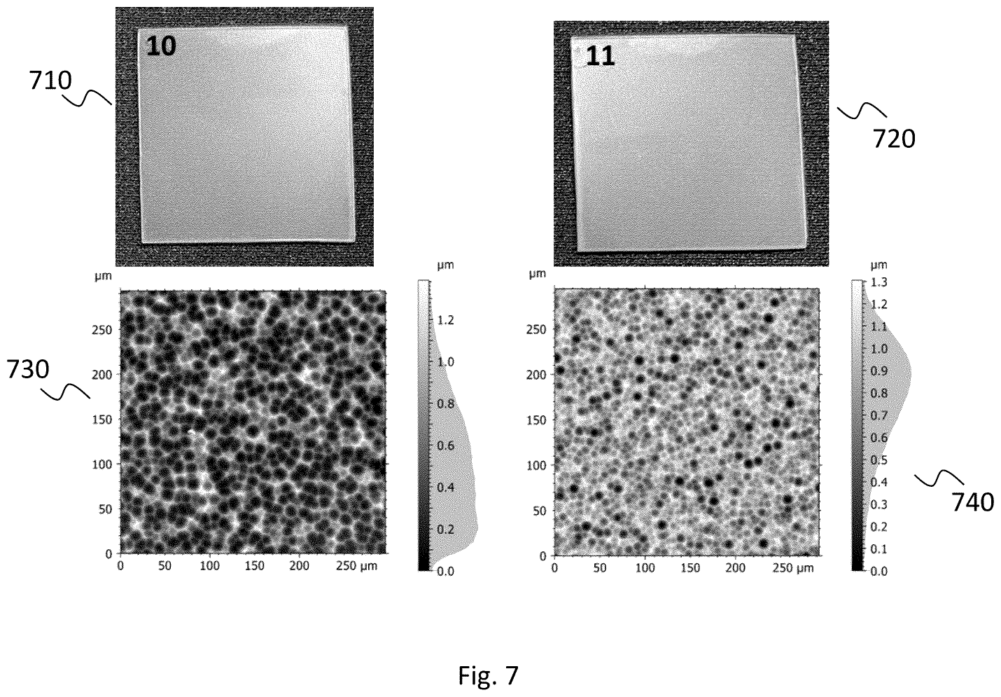

FIG. 7 shows optical microscope images of the polished regions for Samples 10 and 11. Specifically, FIG. 7 shows optical micrograph image 710 and image 730 for Sample 10, and image 720 and image 740 for Sample 11. Image 730 and image 740 also include a probability distribution function for feature height for Samples 10 and 11, respectively.

Samples 10 and 11, after polishing, were evaluated for RSm, Sq, Haze, Coupled DOI and Sparkle. RSm is the mean width of the profile elements, i.e., the arithmetic mean value of the width of the roughness profile elements within the sampling length, which is measured using a ZYGO® NEWVIEW™ 7300 Optical Surface Profiler manufactured by ZYGO®, according to ISO 4287. Sq is the root mean square height, which is equivalent to the standard deviation of the feature height probability distribution, also measured using the Zygo Surface Profiler described above according to ISO25178. The results of these measurements are shown in Table 5.

TABLE 5

| Recipe # | RSm (um) | Sq (um) | Haze | Coupled DOI | Sparkle 140 ppi |
|---|---|---|---|---|---|
| 10 | 19.01 | 0.28 | 37.3 | 99.04 | 3.54 |
| 11 | 14.88 | 0.23 | 38.4 | 93.63 | 3.75 |

Many variations and modifications may be made to the above-described embodiments of the disclosure without departing substantially from the spirit and various principles of the disclosure. All such modifications and variations are intended to be included herein within the scope of this disclosure and protected by the following claims.

What is claimed is:

1. A glass ceramic article, comprising:
a first primary surface and a second primary surface separated by a thickness, wherein the first primary surface comprises a textured region,
a transmittance haze of greater than or equal to 10% to less than or equal to 40%;
a sparkle of greater than or equal to 1% to less than or equal to 5% as measured by pixel power distribution (PPD) at 140 ppi; and
a coupled distinctness of image (DOI) of greater than or equal to 50% to less than or equal to 99.9%; and
wherein the glass-ceramic article is made of a material that has a transmittance of at least 90% for light in a wavelength range from 400 nm to 800 nm at a thickness of 1 mm.

2. The glass-ceramic article of claim 1, wherein the textured region has a mean width of profile elements (RSM) of greater than or equal to 10 microns to less than or equal to 30 microns.

3. The glass-ceramic article of claim 1, wherein the textured region has a root mean square height (Sq) of greater than or equal to 0.1 microns to less than or equal to 0.5 microns.

4. The glass-ceramic article of claim 1, wherein the glass-ceramic substrate comprises:
a petalite crystalline phase; and
a lithium silicate crystalline phase,
wherein the petalite crystalline phase and the lithium silicate crystalline phase have higher weight percentages than other crystalline phases present in the glass-ceramic article.

5. The glass-ceramic article of claim 1, wherein the petalite crystalline phase comprises 20 to 70 wt % of the glass-ceramic article and the lithium silicate crystalline phase comprises 20 to 60 wt % of the glass ceramic substrate.

6. The glass-ceramic article of claim 1, wherein the glass ceramic substrate is made of a material that has a transmittance of at least 90% for light in a wavelength range from 400 nm to 800 nm at a thickness of 1 mm.

7. The glass-ceramic article of claim 1, wherein the glass-ceramic article has a composition comprising, in wt %:
SiO₂: 55-80%;
Al₂O₃: 2-20%;
Li₂O: 5-20%;
B₂O₃: 0-10%;
Na₂O: 0-5%;
ZnO: 0-10%;
P₂O₅: 0.5-6%; and
ZrO₂: 0.2-15%.

8. The glass-ceramic article of claim 1, wherein the article further comprises a compressive stress region that extends from the first primary surface to a selected depth.

9. The glass-ceramic article of claim 1, wherein the article further comprises a consumer electronic device.

10. A method of making a glass-ceramic article having a textured region, comprising:
acid rinsing a glass-ceramic substrate in a rinsing solution comprising HF, and optionally HCl, to form a rinsed region;
etching the rinsed region in an etching solution comprising HF and NH₄F, and optionally KCl, NaCl, MgCl₂, propylene glycol and mixtures thereof; to form an etched region;
chemically polishing the etched region in a polishing solution comprising HF, and optionally HCl, HNO₃ and mixtures thereof, to form the textured region.

11. The method of claim 10, wherein:
the glass-ceramic substrate comprises a first primary surface and a second primary surface separated by a thickness;
the second primary surface is covered by a protective film during the acid rinsing, etching and chemical polishing, such that the second primary surface is excluded from the rinsed region, the etched region and the textured region; and
the rinsed region, the etched region and the textured region comprise the first primary surface.

12. The method of claim 10, wherein:
the rinsing solution comprises greater than or equal to 1 wt % to less than or equal to 10 wt % HF, and greater than or equal to 5 wt % to less than or equal to 30 wt % HCl.

13. The method of claim 10, wherein the acid rinsing comprises exposing the substrate to the rinsing solution for greater than or equal to 0.5 minutes to less than or equal to 3 minutes.

14. The method of claim 10, wherein:
the etching solution comprises:
an etchant comprising greater than or equal to 1 wt % to less than or equal to 20 wt % HF,
a masking component comprising greater than or equal to 5 wt % to less than or equal to 50 wt % NH₄,
a masking modifier comprising:
greater than or equal to 0 wt % to less than or equal to 20 wt % KCl,
greater than or equal to 0 wt % to less than or equal to 20 wt % NaCl;
greater than or equal to 0 wt % to less than or equal to 20 wt % MgCl₂; and
greater than or equal to 0 wt % to less than or equal to 30 wt % propylene glycol;
wherein at least one of the KCl, NaCl, MgCl₂ and propylene glycol is present in an amount greater than or equal to 0.1 wt %.

15. The method of claim 10, wherein the etching comprises exposing the substrate to the etching solution for greater than or equal to 2 minutes to less than or equal to 20 minutes.

16. The method of claim 10, wherein:
the polishing solution comprises:
a polisher comprising greater than or equal to 1 wt % to less than or equal to 10 wt % HF, and
a polishing modifier comprising greater than or equal to 0 wt % to less than or equal to 30 wt % HCl and greater than or equal to 0 wt % to less than or equal to 30 wt % HNO₃.

17. The method of claim 10, wherein the polishing comprises exposing the substrate to the polishing solution for greater than or equal to 20 minutes to less than or equal to 120 minutes.

18. The method of claim 10, wherein the glass-ceramic substrate comprises:
a petalite crystalline phase; and
a lithium silicate crystalline phase,
wherein the petalite crystalline phase and the lithium silicate crystalline phase have higher weight percentages than other crystalline phases present in the glass-ceramic article.

19. The method of claim 10, wherein the petalite crystalline phase comprises 20 to 70 wt % of the glass-ceramic article and the lithium silicate crystalline phase comprises 20 to 60 wt % of the glass ceramic substrate.

20. The method of claim 10, wherein the glass-ceramic article has a composition comprising, in wt %:
SiO₂: 55-80%;
Al₂O₃: 2-20%;
Li₂O: 5-20%;
B₂O₃: 0-10%;
Na₂O: 0-5%;
ZnO: 0-10%;
P₂O₅: 0.5-6%; and
ZrO₂: 0.2-15%.
